(19) United States
(12) Patent Application Publication
(10) Pub. No.: US 2024/0248108 A1
(43) Pub. Date: Jul. 25, 2024

(54) AUTOMATED LIQUID DISPENSING SYSTEMS

(71) Applicant: Australian Laboratory Services Pty. Ltd., Stafford, Queensland (AU)

(72) Inventors: Kieran SCHNEIDER, Stafford (AU); Jan HAVLIK, North Vancouver (CA); Archibald Donald ROBERTSON, North Vancouver (CA)

(21) Appl. No.: 17/927,314

(22) PCT Filed: Jun. 1, 2021
(86) PCT No.: PCT/CA2021/050744

§ 371 Date: Nov. 22, 2022

Related U.S. Application Data
(60) Provisional application No. 63/034,773, filed on Jun. 4, 2020.

(51) Int. Cl. G01N 35/10

(52) U.S. Cl. CPC G01N 35/1002; G01N 35/1011; G01N 35/1016

(57) ABSTRACT

The present disclosure provides an apparatus for dispensing fluid from a reagent container having a pump comprising a control and an outlet whereby moving the control causes fluid to flow from the outlet. The apparatus comprises a pump actuator assembly comprising a first bracket configured to be mounted on the reagent container, a second bracket configured to engage the control, and a pump actuator connected to move the second bracket relative to the first bracket; a dispenser assembly comprising a dispensing nozzle, a nozzle positioning mechanism configured to move the dispensing nozzle through a plurality of positions, and a flexible tube having a first end connected to the dispensing nozzle and a second end connectible to the outlet of the pump; and a controller in communication with the dispenser assembly and the pump actuator assembly for controlling the pump actuator and the nozzle positioning mechanism.

### CROSS REFERENCE TO RELATED APPLICATION

This application claims the benefit of priority of U.S. Provisional Patent Application No. 63/034,773 filed Jun. 4, 2020, which is hereby incorporated herein by reference in its entirety.

### TECHNICAL FIELD

The present disclosure relates to dispensing liquids. Particular embodiments relate to apparatus, methods and systems for safely and precisely dispensing controlled amounts of liquids.

### BACKGROUND

There are a number of situations where liquids need to be dispensed into containers repeatedly and in controlled amounts. For example, many laboratory tests involve adding reagents to samples held in a plurality of test tubes in racks. Some reagents, such as strong industrial acids, can be highly corrosive, hazardous and produce toxic fumes, and subject to stringent safety regulations.

Prior art examples of liquid dispensing systems include:
U.S. Pat. No. 8,071,053 to S. Matsuzaki et al.
U.S. Ser. No. 10/514,329 to A. Toms
U.S. Pat. No. 5,260,028 to T. Astle
U.S. Pat. No. 5,215,377 to Y. Sugano
U.S. Pat. No. 8,262,993 to D. Wiederin et al.
U.S. Pat. No. 7,469,606 to D. Wiederin
U.S. Pat. No. 6,455,316 to H. Turner et al.
U.S. Pat. No. 5,158,748 to H. Obi et al.
U.S. Pat. No. 4,841,786 to P. Schulz
US20090261124 to D. Boll et al.
U.S. Pat. No. 8,668,118 to H. Tsai et al.
U.S. Pat. No. 8,573,443 to M. Natterer
U.S. Pat. No. 8,342,369 to C. Hsu
U.S. Pat. No. 7,753,238 to P. Kirschenbuhler

The inventors have determined a need for improved apparatus, methods and systems for safely and precisely dispensing controlled amounts of liquids.

### SUMMARY

One aspect provides an apparatus for dispensing fluid from a reagent container having a pump comprising a control and an outlet whereby moving the control causes fluid to flow from the outlet. The apparatus comprises a pump actuator assembly comprising a first bracket configured to be mounted on the reagent container, a second bracket configured to engage the control, and a pump actuator connected to move the second bracket relative to the first bracket; a dispenser assembly comprising a dispensing nozzle, a nozzle positioning mechanism configured to move the dispensing nozzle through a plurality of positions, and a flexible tube having a first end connected to the dispensing nozzle and a second end connectible to the outlet of the pump; and a controller in communication with the dispenser assembly and the pump actuator assembly for controlling the pump actuator and the nozzle positioning mechanism.

Another aspect provides an apparatus for dispensing fluid from a reagent container, the apparatus comprising, a pump actuator assembly configured to actuate a pump to cause fluid from the reagent container to flow from an outlet, a dispenser assembly comprising a dispensing nozzle, a nozzle positioning mechanism configured to move the dispensing nozzle through a plurality of positions, and a flexible tube having a first end connected to the dispensing nozzle and a second end connectible to the outlet of the pump, and a controller in communication with the dispenser assembly and the pump actuator assembly for controlling the pump actuator assembly and the nozzle positioning mechanism.

Another aspect provides a method for dispensing fluid from a reagent container having a pump comprising a control and an outlet whereby moving the control causes fluid to flow from the outlet. The method comprises: mounting a pump actuator assembly on the pump of the reagent container, the pump actuator assembly comprising a first bracket configured to be mounted on the reagent container, a second bracket configured to engage the control, and a pump actuator connected to move the second bracket relative to the first bracket; connecting a first end of a flexible tube to the outlet of the pump and a second end of the flexible tube to a dispensing nozzle of a dispenser assembly comprising a nozzle positioning mechanism; and controlling the nozzle positioning mechanism to move the dispensing nozzle through a plurality of predetermined positions, and pause at each predetermined position while actuating the pump actuator assembly to dispense a predetermined amount of fluid from the reagent container.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 shows an example liquid dispensing system according to one embodiment of the present disclosure.

FIG. 2 is a sectional view through the dispenser assembly of the liquid dispensing system of FIG. 1.

FIG. 3 shows an example liquid dispensing system for dispensing according to one embodiment of the present disclosure.

FIG. 4 shows an example pulse width modulation curve for driving the pump actuator assembly of the liquid dispensing system of FIG. 1.

FIG. 5 shows an example digital output from the controller to the pump actuator assembly of the liquid dispensing system of FIG. 1.

### DETAILED DESCRIPTION

The following describes apparatus, methods and systems for safely, and precisely, dispensing controlled amounts of liquids or other fluids. In preferred embodiments, the present disclosure provides apparatus configured to be used with existing containers and pump dispensers commonly used in laboratory settings.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

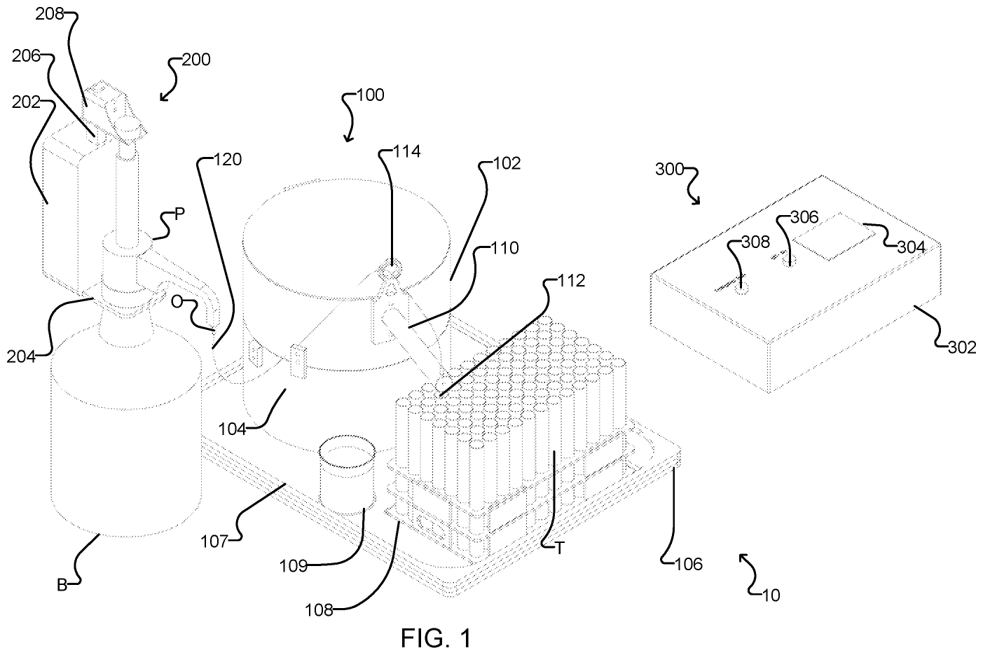

FIG. 1 shows an example liquid dispensing system 10 according to one embodiment of the present disclosure. The system 10 comprises a dispenser assembly 100, a pump actuator assembly 200, and a controller 300. As discussed further below, the system 10 may be activated by a user interacting with the controller 300. In some embodiments, once activated, the controller 300 causes a nozzle positioning mechanism of the dispenser assembly 100 to move a dispensing nozzle 112 through a plurality of positions above a rack of test tubes T, and while the nozzle 112 is over each test tube, causes the pump actuator assembly 200 to eject a precisely controlled volume of liquid.

In the example illustrated in FIG. 1, the pump actuator assembly 200 is configured to be mounted on standard laboratory reagent bottle B with a bottle-top dispenser pump P. The pump P has a plunger which, when depressed, causes liquid to flow from an outlet O. The pump actuator assembly 200 comprises a body 202 having a first bracket 204 configured to be mounted on the reagent container. The body 202 houses a motor or other actuator (not shown) connected (e.g. by a rack and pinion mechanism or other suitable gearing) to move a rod 206 in and out of the body 202, and the rod 206 has a second bracket 208 configured to engage the plunger of the dispenser pump P.

The pump actuator assembly 200 may be differently configured than the example shown in FIG. 1 in other embodiments. For example, in some embodiments, the pump actuator assembly 200 is configured to be mounted on other types of containers/dispensers, and engage other types of pumps, so long as the pump has an outlet to which a flexible tube (as described below) of the dispensing assembly 100 may be attached, and some type of control to move to cause liquid or fluid to flow from the outlet. In the illustrated example, the control is a plunger of a pump, but in other embodiments the control could be, for example, a lever, dial, switch, button, squeezable bulb or other mechanism for causing fluid to flow from the outlet.

In some embodiments, the pump actuator assembly 200 comprises a motor-controlled pump which directly pumps liquid from a variety of types of reservoirs from an outlet to which a flexible tube may be attached. When dispensing hazardous liquids such as acids, there may be safety benefits in using a mechanical pumping mechanism of the type shown in FIG. 1, but such safety benefits may not be present when dispensing less-hazardous liquids or other fluids, and thus another form of motor-controlled liquid pump may be substituted and/or preferable in some embodiments.

In the illustrated example, the nozzle positioning mechanism of the dispenser assembly 100 comprises a rotatable turret 102 mounted on a base 104. In the illustrated example, the base 104 is mounted on a tray 106 with a raised edge 107 to contain any spills. The tray 106 also has a recess 108 for holding a rack of test tubes and a recess 109 for holding a drip container.

The turret 102 has an extendible arm 110 extending therefrom, at the end of which is a dispensing nozzle 112. In the example illustrated in FIG. 1, the dispensing nozzle 112 comprises a tube at the end of the arm 110. A flexible tube 120 is connected to the top of the dispensing nozzle 112, and the other end of the flexible tube 120 is connected to the outlet O of the pump P. An eyelet 114 is mounted on the turret 102 near the base of the arm 110 for holding the flexible tube 120 up away from the nozzle 112.

In some embodiments the internal diameter of the flexible tube 120 and dispensing nozzle 112 is selected based on the characteristics of the liquid being dispensed. In some embodiments the diameter is sufficiently large, given the viscosity of the liquid being dispensed, to allow pump P to dispense the liquid from the dispensing nozzle 112, and sufficiently narrow, given the surface tension of the liquid being dispensed, such that when pump P ceases its pumping action, entry of gas into, or further flow of liquid from, the dispensing nozzle 112 is prevented due to the formation of a static meniscus at the dispensing nozzle 112.

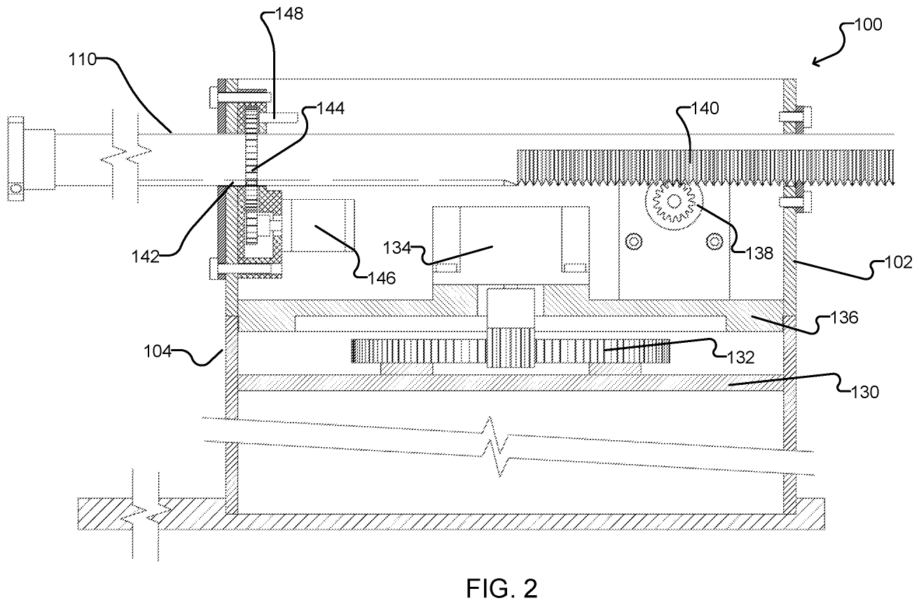

As shown in FIG. 2, the base 104 of dispenser assembly 100 has a mounting plate 130 therein that holds yaw gears 132 driven by a yaw motor 134. The mounting plate 130 is raised up from the bottom of the base 104 so that any liquids that might fall onto the tray 106 and seep into base 104 do not come into contact with the internal components of dispenser assembly 100. The yaw motor 134 is mounted on another mounting plate 136 at the bottom of turret 102, such that the whole turret 102 rotates when the yaw motor 134 is activated. An advancement motor 138 is also mounted on mounting plate 136, and engages teeth 140 on the extendible arm 110, such that the arm 110 can be moved inwardly and outwardly from the turret 102 by activating the advancement motor 138.

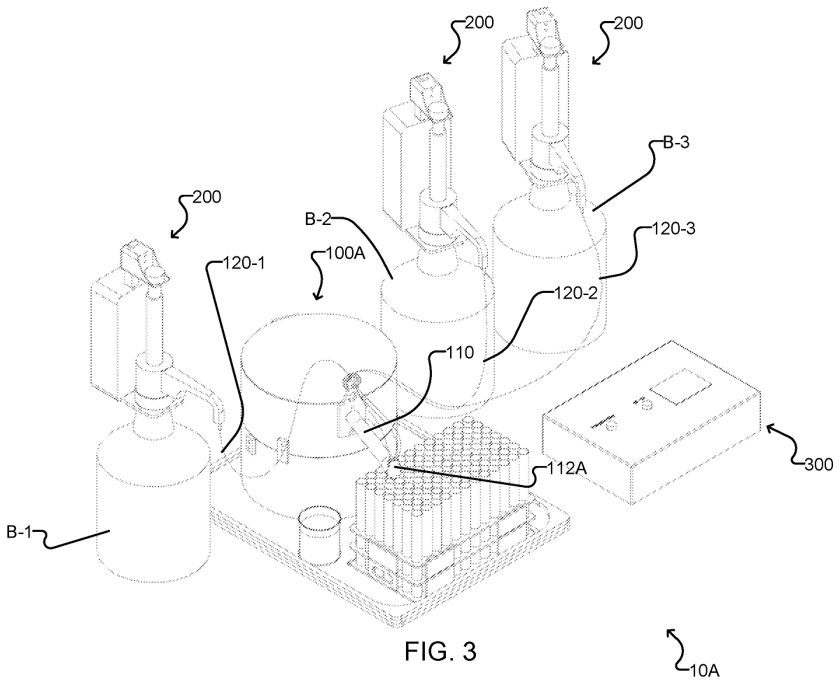

In some embodiments, the arm 110 may be configured to have more than one dispensing nozzle. For example, FIG. 3 shows an example liquid dispensing system 10A with three dispensing nozzles 112A (in the illustrated example of FIG. 3, all three nozzles 112A are formed in a single component, but in other embodiments the nozzles 112A could be formed by different components, such as three separate tubes at different angles at the end of arm 110). A separate flexible tube 120-1, 120-2, 120-3 is connected between each of the nozzles 112A and one of three separate reagent bottles B-1, B-2, B-3, and each of the bottles B-1, B-2, B-3 has its own dispenser pump P with a pump actuator 200 coupled thereto. In some such embodiments, in addition to being extendible, the arm 110 is also rotatable about its longitudinal axis. Referring back to FIG. 2, in some embodiments rotation of the arm 110 is effected by a roll slot 142 in the arm that is engaged by a pin connected to a roll gear mechanism 144 engaged by a roll motor 146. A roll angle sensor 148 measures the roll angle of the arm 110 and provides feedback to the controller 300. The arm 110 may be controlled to dispense any one of the different reagents by rotating the arm 110 to place the bottom of the nozzle connected to the desired reagent bottle at the bottom of the arm 110. For example, in some embodiments, the arm 110 rotates around its horizontal axis (roll) to position a selected one of the nozzles 112A over a test tube T, to accommodate different reagent to be dispensed in that tube without potential of misalignment or contamination.

In some embodiments, the arm 110 is also moveable to adjust the height of the nozzle 112. For example, in some embodiments the arm 110 is connected to pivot about a horizontal axis through its interior end, such that the height of the nozzle 112 can be adjusted by pivoting the arm 110.

In some embodiments, the dispenser assembly 100 is adaptable for use with differing test tube heights by other means. For example, in some embodiments, fixed-height spacer rings are provided, having the same outer diameter as base 104, and configured to be inserted between the base 104 and the tray 106 to raise the dispenser assembly 100. In some embodiments a variable-height spacer ring (either motor-actuated or manually-adjustable) is provided between the base 104 and the tray 106 to raise the dispenser assembly 100. In some embodiments, the tray 106 has a variable depth recess (for example by having a moveable bottom, or providing spacers).

In some embodiments, all of the exposed portions of the dispenser assembly 100 and pump actuator assembly 200 are constructed from corrosion resistant materials (such as, for example PVC or other plastics). For example, in some embodiments, the components are 3D printed using acid resistant plastic, and are connected using fasteners constructed from polyether ether ketone (PEEK).

The controller 300 comprises a housing 302 containing drivers for the motors of the dispenser assembly 100 and pump actuator assembly 200. The controller also comprises a microcontroller or other processor connected to the motor drivers.

In the illustrated example, the controller 300 comprises a user interface consisting of a display 304, an on/off switch 306, and an emergency stop 308. In other embodiments, the controller 300 may have different user interfaces. For example, in some embodiments, the controller 300 may have inputs allowing a user to select from one of a plurality of predetermined dispensing sequences. In some embodiments, the controller 300 is configured to provide pulse width modulation (PWM) signals to the drivers for the pump actuator and the motors of the nozzle positioning mechanism.

In some embodiments, the system 10 comprises a pressure sensor embedded in or mounted on tray 106, an optical sensor near tray 106, or other sensor configured to detect the presence of a rack of test tubes T. In such embodiments, the controller 300 receives signals from such sensors and is configured to prevent dispensing of liquids if the signals indicate that there are no test tubes present.

In some embodiments, the controller 300 is programmed to cause the dispenser assembly 100 and pump actuator assembly 200 to execute a predetermined sequence of actions. For example, with reference to the FIG. 1 example, in some embodiments, once activated by a user, the controller 300 is programmed to execute a sequence for filling a rack of test tubes T in a 7×12 rectangular array, wherein the nozzle positioning mechanism is actuated to move the dispensing nozzle 112 over each of the 84 individual test tubes sequentially, and while the nozzle 112 is over each test tube the pump actuator is activated. The controller 300 can be configured for any standard racks (e.g., 21 positions (3×7), 40 positions (4×10), 60 positions (5×12) and 90 positions (6×15)), or custom racks, by reprogramming with the desired tube coordinates. Similarly, in some embodiments the controller 300 is configured for use with a pump actuator assembly 200 adapted for a particular type of bottle B/pump P, and in some embodiments the controller 300 may be reprogrammed and/or recalibrated for use with a differently configured pump actuator assembly adapted for a different type of pump or container, or preprogrammed with a variety of different settings for controlling pump actuator assemblies for different types of pumps. In some embodiments the controller 300 is configured to move the nozzle over a drip container in recess 109 and cause the pump actuator to move through one or more strokes before executing a filling sequence to ensure the flexible tube is full of liquid.

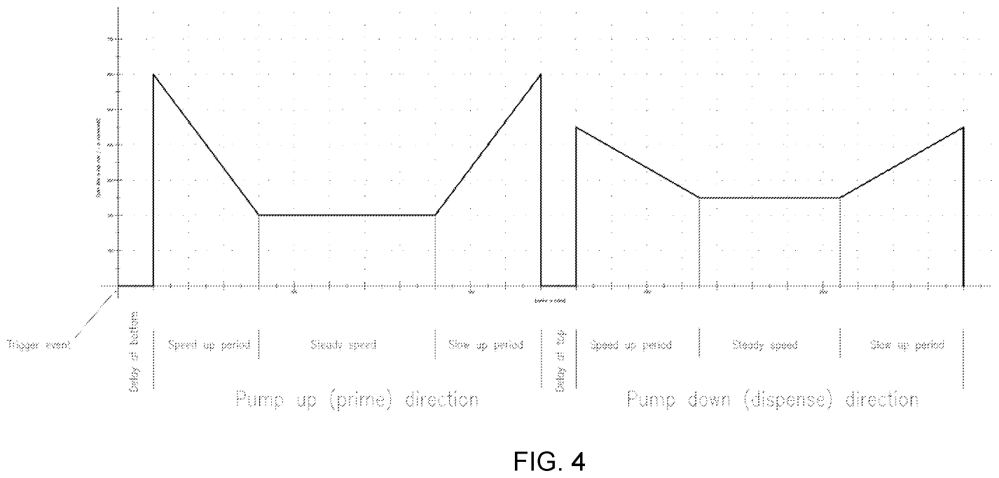

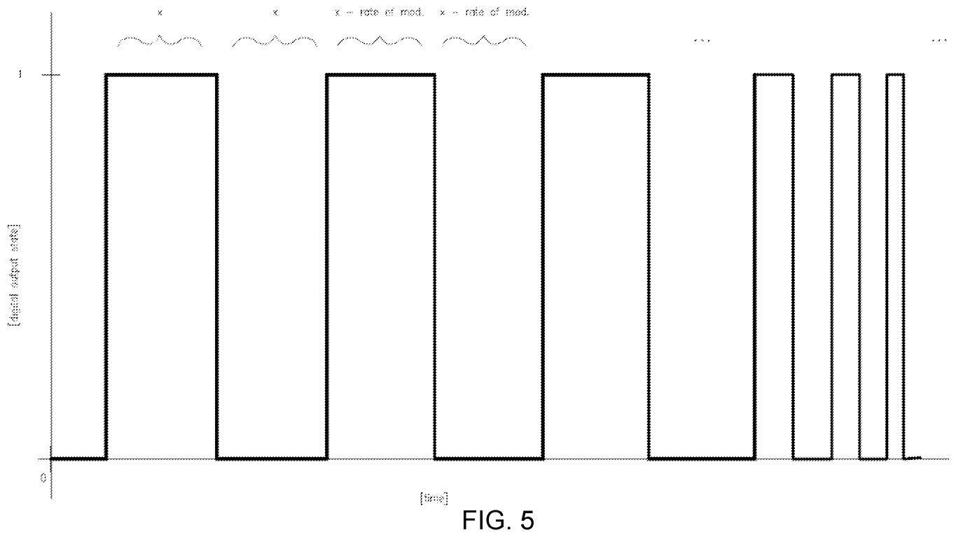

In some embodiments, the amount of liquid dispensed from the pump P can be affected by not only the length of travel but also the speed and acceleration of the plunger of the pump, and the controller 300 is configured to precisely control the motion of the plunger and thus the amount of liquid dispensed into each test tube. For example, FIG. 4 shows an example PWM curve for driving the pump actuator according to some embodiments. Once a triggering event occurs (e.g. the controller has moved the dispensing nozzle over a test tube and determined that the nozzle is in the correct position), there is a short delay, then the pump actuator accelerates the plunger upwardly, then moves the plunger upwardly at a steady speed, then decelerates until the pump actuator has moved through a predetermined upward distance for priming the pump. At the top of the stroke there is another short delay, then the pump actuator accelerates the plunger downwardly, then moves the plunger downwardly at a steady speed, then decelerates until the pump actuator has moved back to the bottom of its stroke and the desired amount of liquid has been dispensed. FIG. 5 shows an example output signal from the microcontroller of the controller 300 to the pump actuator driver.

The embodiments of the systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface. For example, the programmable computers may be a server, network appliance, set-top box, embedded device, computer expansion module, personal computer, laptop, personal data assistant, connected or autonomous vehicle, cloud computing system or mobile device. A cloud computing system is operable to deliver computing service through shared resources, software and data over a network.

Program code is applied to input data to perform the functions described herein and to generate output information. The output information is applied to one or more output devices to generate a discernable effect. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. In any case, the language may be a compiled or interpreted language. Each such computer program may be stored on a storage media or a device (e.g. ROM or magnetic diskette), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Embodiments described herein may relate to various types of computing applications, such as image processing and generation applications, computing resource related applications, speech recognition applications, video processing applications, semiconductor fabrication, and so on. By way of illustrative example embodiments may be described herein in relation to image-related applications.

Throughout the foregoing discussion, numerous references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments of the present disclosure may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various example embodiments described herein.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As will be apparent to those skilled in the art in light of the foregoing disclosure, many alterations and modifications are possible to the methods and systems described herein. While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as may reasonably be inferred by one skilled in the art. The scope of the claims should not be limited by the embodiments set forth in the examples, but should be given the broadest interpretation consistent with the foregoing disclosure.

The present disclosure may be embodied in other specific forms without departing from its spirit or essential characteristics. The described embodiments are to be considered in all respects only as illustrative and not restrictive.

1. An apparatus for dispensing fluid from a reagent container having a pump comprising a control and an outlet whereby moving the control causes fluid to flow from the outlet, the apparatus comprising:
a. a pump actuator assembly comprising a first bracket configured to be mounted on the reagent container, a second bracket configured to engage the control, and a pump actuator connected to move the second bracket relative to the first bracket;
b. a dispenser assembly comprising a dispensing nozzle, a nozzle positioning mechanism configured to move the dispensing nozzle through a plurality of positions, and a flexible tube having a first end connected to the dispensing nozzle and a second end connectible to the outlet of the pump; and
c. a controller in communication with the dispenser assembly and the pump actuator assembly for controlling the pump actuator and the nozzle positioning mechanism.

2. The apparatus of claim 1 wherein the nozzle positioning mechanism comprises a turret rotatably mounted on a base, wherein the turret comprises an extendible arm projecting radially with respect to an axis of rotation of the turret and having the dispensing nozzle at a distal end thereof.

3. The apparatus of claim 2 wherein the nozzle positioning mechanism comprises yaw gears mounted on a first mounting plate above a bottom of the base, a yaw motor mounted on a second mounting plate at the bottom of the turret, and an advancement motor mounted on the second mounting plate.

4. The apparatus of claim 3 wherein the dispenser assembly comprises a plurality of dispensing nozzles, and the nozzle positioning mechanism is configured to position a selected one of the dispensing nozzles over a dispensing location.

5. The apparatus of claim 4 wherein the nozzle positioning mechanism comprises a roll motor connected to a roll gear mechanism for rotating the extendible arm about its longitudinal axis.

6. The apparatus of claim 1 wherein the control comprises a plunger and the pump actuator assembly is configured to depress the plunger.

7. The apparatus of claim 1 wherein the flexible tube has an internal diameter selected based on a surface tension of a liquid being dispensed to form a static meniscus at the dispensing nozzle when the pump ceases a pumping action, to prevent entry of gas into, or further flow of liquid from, the dispensing nozzle.

8. An apparatus for dispensing fluid from a reagent container, the apparatus comprising:
a. a pump actuator assembly configured to actuate a pump to cause fluid from the reagent container to flow from an outlet;
b. a dispenser assembly comprising a dispensing nozzle, a nozzle positioning mechanism configured to move the dispensing nozzle through a plurality of positions, and a flexible tube having a first end connected to the dispensing nozzle and a second end connectible to the outlet of the pump; and
c. a controller in communication with the dispenser assembly and the pump actuator assembly for controlling the pump actuator assembly and the nozzle positioning mechanism.

9. The apparatus of claim 8 wherein the pump actuator assembly comprises a motor-controlled pump.

10. The apparatus of claim 8 wherein the reagent container comprises a manual pump dispenser having a plunger, and wherein the pump actuator assembly is configured to depress the plunger.

11. The apparatus of claim 10 wherein the pump actuator assembly comprises a first bracket configured to be mounted on the reagent container, a second bracket configured to engage the plunger, and a pump actuator connected to move the second bracket relative to the first bracket.

12. A method for dispensing fluid from a reagent container having a pump comprising a control and an outlet whereby moving the control causes fluid to flow from the outlet, the method comprising:
a. mounting a pump actuator assembly on the pump of the reagent container, the pump actuator assembly comprising a first bracket configured to be mounted on the reagent container, a second bracket configured to engage the control, and a pump actuator connected to move the second bracket relative to the first bracket;
b. connecting a first end of a flexible tube to the outlet of the pump and a second end of the flexible tube to a dispensing nozzle of a dispenser assembly comprising a nozzle positioning mechanism; and
c. controlling the nozzle positioning mechanism to move the dispensing nozzle through a plurality of predetermined positions, and pause at each predetermined position while actuating the pump actuator assembly to dispense a predetermined amount of fluid from the reagent container.

13. The method of claim 12 wherein the nozzle positioning mechanism comprises a turret rotatably mounted on a base, wherein the turret comprises an extendible arm projecting radially with respect to an axis of rotation of the turret and having the dispensing nozzle at a distal end thereof, and wherein moving the dispensing nozzle through the plurality of predetermined positions comprises rotating the turret relative to the base while extending and retracting the extendible arm.

14. The method of claim 12 wherein the control of the pump comprises a plunger, and wherein actuating the pump actuator assembly to dispense the predetermined amount of fluid comprises, in sequence:
a. accelerating the plunger upwardly from a bottom of stroke;
b. moving the plunger upwardly at a steady speed;
c. decelerating the plunger until the pump actuator has moved through a predetermined upward distance for priming the pump to a top of stroke;
d. dwelling briefly at the top of stroke;
e. accelerating the plunger downwardly;
f. moving the plunger downwardly at a steady speed; and
g. decelerating the plunger until the pump actuator has moved back to the bottom of stroke and the predetermined amount of fluid has been dispensed.
